(19) United States
(12) Patent Application Publication
(10) Pub. No.: US 2003/0232245 A1
(43) Pub. Date: Dec. 18, 2003

(54) Interactive training software

(75) Inventors: Jeffrey A. Turak, Granger, IN (US); Jared K. Smith, Bountiful, UT (US)

Correspondence Address: Intellectual Property Group, Bose McKinney & Evans LLP, 2700 First Indiana Plaza, 135 North Pennsylvania Street, Indianapolis, IN, 46204, US

(73) Assignee: Jeffrey A. Turak

(21) Appl. No.: 10/170,811

(22) Filed: Jun. 13, 2002

(51) Int. Cl. H01M 4/58; H01M 4/48; H01M 4/50; H01M 4/52; B05D 5/12

(52) U.S. Cl. 429/231.95; 429/231.1; 429/231.3; 429/224; 429/223; 429/231.2; 429/231.5; 429/231.6

(57) ABSTRACT

Software for simulating human interaction, including code for generating a questionnaire, code for generating a computerized presentation, code for presenting the questionnaire to a user, and code for generating a recording of input provided by the user during the presentation. The input includes responses of the user to the questionnaire. The software further includes code for enabling playback of the recording for review.

### FIELD OF THE INVENTION

The present invention generally relates to software for simulating human interaction for training purposes, and more specifically to software that includes a configurable, interactive presentation and code that records a user's responses to the presentation for review.

### BACKGROUND OF THE INVENTION

Training software typically includes a presentation that is created to instruct a user such as an employee on specific subjects such as sales tactics or interpersonal relations. Generally, the software is loaded onto a computer and the user views or listens to the presentation. Some software allows the user to depress a keyboard key or a mouse button to advance through the presentation step by step.

In order to provide interactive training software that allows the user or some other person such as the user's supervisor to review the user's responses to the presentation, it is desirable to record the user's responses to the presentation. Additionally, to improve or update the presentation, it is desirable to enable the user to modify the presentation. Interactive training software that can record a user's responses to a presentation of questions should also be accessible from a remote location via a computer network.

These features and advantages of the present invention, as well as additional features and advantages, will be readily apparent to those skilled in the art upon reference to the following description and the accompanying drawings.

### BRIEF DESCRIPTION OF THE DRAWINGS

FIG. 1 is a block diagram of one embodiment of a system for operating software according to the present invention.

FIG. 2 is a flow diagram of an embodiment of the interactive training software.

FIG. 3 is a flow diagram for selecting a training questionnaire.

FIG. 4 is a flow diagram for recording a new questionnaire.

FIG. 5 is a flow diagram for modifying a questionnaire.

FIG. 6 is a flow diagram for modifying a training presentation.

FIG. 7 is a flow diagram for starting a training software.

FIG. 8 is a flow diagram for concluding a training session.

FIG. 9 is a block diagram for another embodiment according to the present invention.

FIG. 10 is a flow diagram for remotely accessing the interactive training software.

### DETAILED DESCRIPTION OF EMBODIMENTS OF THE INVENTION

The embodiments described below are merely exemplary and are not intended to limit the invention to the precise forms disclosed. Instead, the embodiments were selected for description to enable one of ordinary skill in the art to practice the invention.

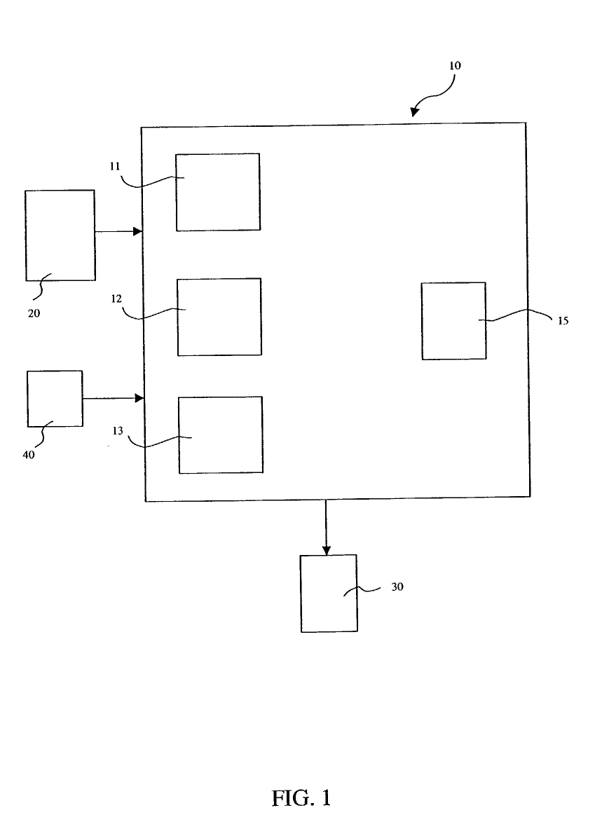

As shown in FIG. 1, a hardware system such as a computer 10 may be used to run the interactive training software of the present invention. Memory 11 may be used to store collected information and the software. An example of memory 11 is a conventional hard drive. Central processing unit 12 accesses the software stored in memory 11 and runs the software. Computer 10 may also include removable memory 13. Removable memory 13 may be used by the software to store information on media such as a compact disk for removal and use on another computer. Display 15 may be used to view a presentation generated by the software. Display 15 may include s conventional computer monitor, a television screen, or any other suitable display device. Input device 40 allows users to input information into computer 10. Input device 40 may include a keyboard, a mouse, or any other suitable input device. Data input 20 transfers data to computer 10. Data input 20 may include a camera, a microphone, or any other suitable device for capturing a user's responses. Output device 30 may be used to transfer data from computer 10 to another computer.

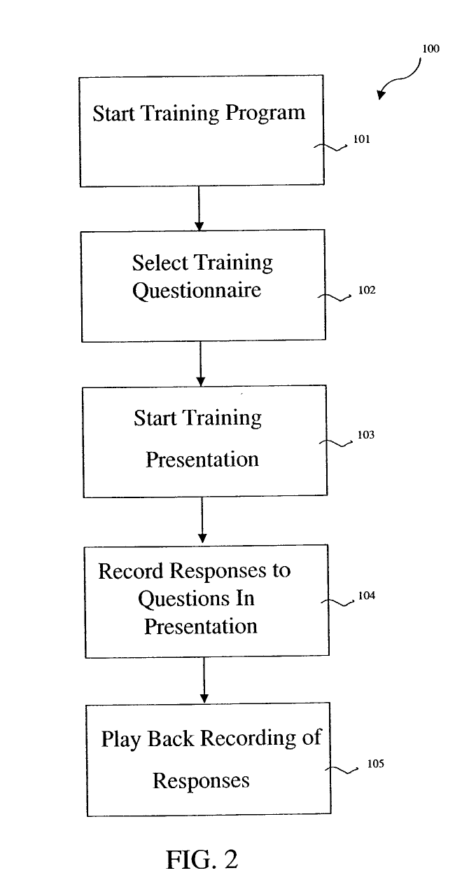

As shown in FIG. 2, interactive training software 100 is comprised of a series of steps. Step 101 initiates interactive training software 100 after interactive training software 100 has been loaded onto computer 10. As should be apparent to one of ordinary skill in the art, there are a variety of methods for initiating the software such as using input device 40, a graphical user interface or otherwise inputting a start command. In step 102, the user selects the desired training questionnaire from a menu of previously generated questionnaires. The questionnaire is a list of questions generated for a specific training session. For example, an employer may prepare training questionnaires for sales representatives that include questions potential clients or customers might ask the sales representatives. Such a questionnaire could then be used to train the sales representatives. Alternatively, the questionnaire could be designed to improve job interview skills by including questions that may typically be asked during an interview. In step 103, the user starts the training presentation.

The training presentation involves an animated character or simulated being generated by software 100 on display 15. The being asks the user questions from the selected questionnaire. This allows the user to practice his or her responses to realistic scenarios. In step 104, the user's responses to the questions asked by the animated character are recorded by data input 20. It should be understood that steps 103 and 104 may alternate such that each response is recorded after each question. In step 105, the recording of the responses is played back to the user on display 15 or to a third party reviewing the user's performance. The recording can be reviewed in either of two formats. In the first format, the simulated being asks the question on display 15. After, the simulated being asks the question, the user actuates input device 40 to play the corresponding recorded response on display 15. In the second format, display 15 appears as a split-screen. The user's recorded response appears on a portion of display 15, and simultaneously the simulated being appears on another portion of display 15. After the simulated being asks the question, the user actuates input device 40 to play the corresponding recorded response on display 15. The reviewer can view or listen to the recording multiple times to determine areas that need improvement. The recording can also be stored as a file on removable media 13 or memory 11. The stored recording can be played at a later time by the user or another person such as the user's employer or instructor.

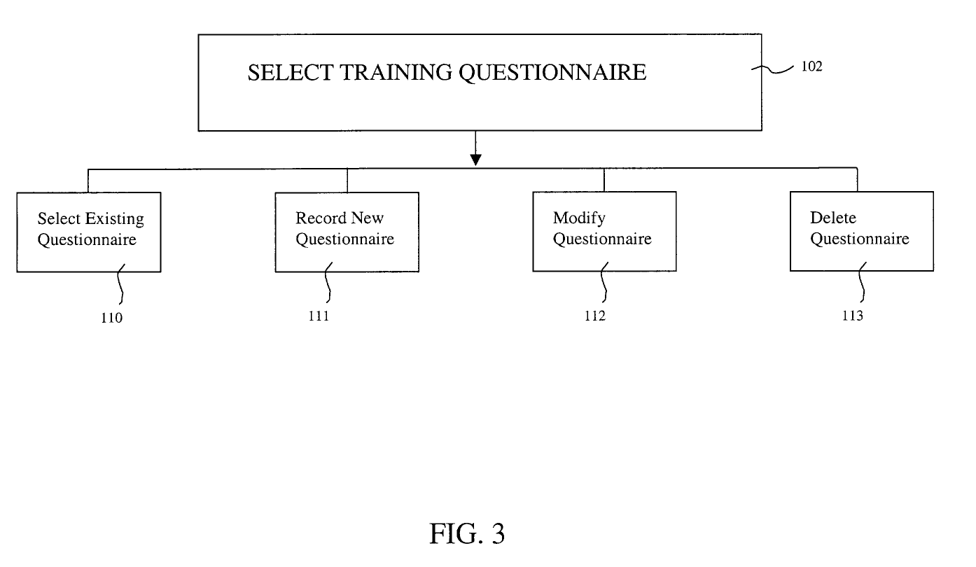

As shown in FIG. 3, step 102 of FIG. 2 allows the user to select a training questionnaire. Interactive training software 100 may include several other options relating to questionnaires. In step 110, the user may select an existing questionnaire to be used for the presentation. The questionnaires may be designed for different training purposes. For example, an employer may create questionnaires with questions about different products or services. The user may also record a new questionnaire as indicated by step 111. The user may create new questionnaires by entering questions into a computer running software 100 via input device 40. The questions are stored memory 11 of computer 10 for later retrieval and playback during a computerized presentation. The user may also modify a new or existing questionnaire as indicated by step 112. The user may change or customize existing questions in the questionnaire, add new questions to the questionnaire, or delete questions from the questionnaire as further described below. The user also has the option of deleting entire questionnaires as indicated by step 113.

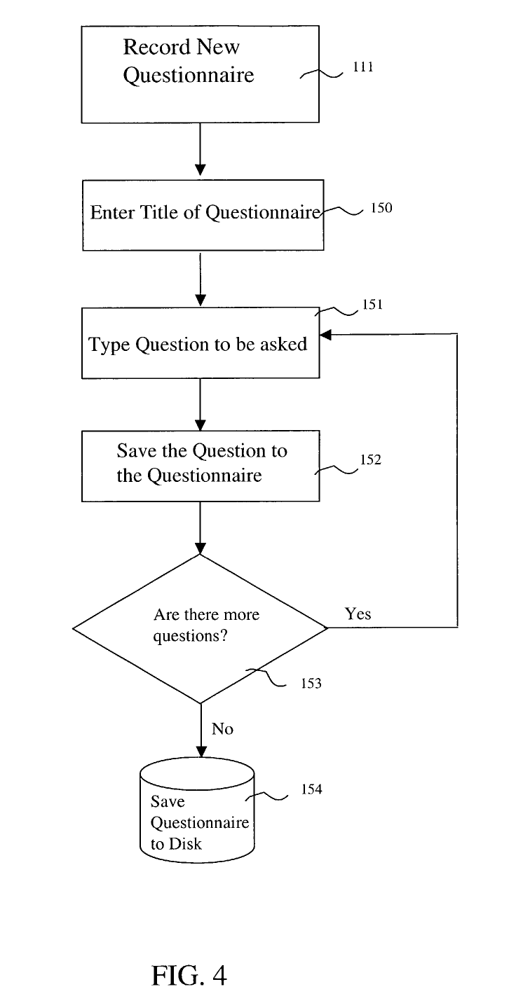

Referring now to FIG. 4, the user records a new questionnaire by activating a “new questionnaire” icon (not shown) on display 15 using input device 40 this evokes step 111. In step 150, the user may enter a title for the new questionnaire using input device 40. In step 151, the user may enter a question he or she desires to be asked during the training presentation. The user may type the question using input device 40 or may record the question by using data input 20. The interactive training software converts questions typed or otherwise inputted into the software by the user into an audio/visual format such as an animation including a being (e.g., a person with visible, physical features that move in synchronization with the audio portion of the presentation). In this manner, the simulated being poses the newly created questions to the user. In step 152, the new question is added to the questionnaire and saved or stored memory 11 as part of the computer file containing the questionnaire information. In step 153, the software presents the user with the option of adding more new questions to the questionnaire. If the user elects to add another question, then the software returns to step 151 and asks the user to enter the new question. If there are no further questions to be added, then the software evokes step 154 in which the questionnaire is saved or stored in memory 11. After the questionnaire is stored, it can be selected for use in a training presentation at step 102 of FIG. 3. In an alternative embodiment, the user can create or modify a questionnaire by selecting questions to be added to the questionnaire from a pre-existing list of questions. The user can create or record a plurality of questionnaires using the process depicted in FIG. 4.

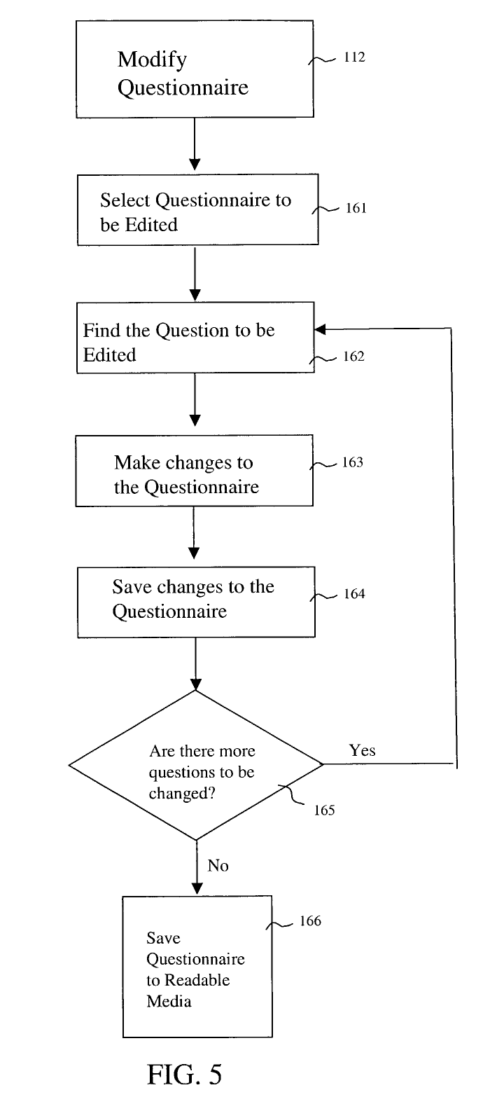

As shown in FIG. 5, pre-recorded questionnaires may also be modified using the software of the present invention. To modify a questionnaire, the user activates with input device 40 a “modify questionnaire” icon (not shown) on display 15 with input device 40 that evokes step 112. In step 161, the software presents a list of pre-recorded questionnaires retrieved from memory 11 and prompts the user to select a questionnaire to be edited. When the user selects a questionnaire using input device 40, the software retrieves the questionnaire from memory 11 and presents the user with a list of questions included in the selected questionnaire on display 15. In step 162, the software prompts the user to select a question to be edited. In step 163, the software presents the full question to the user for editing. The user may edit the question using conventional word processing techniques or any other suitable process. After the user has made the desired changes to the selected question, the modified question is saved or stored in memory 11 as part of the selected questionnaire. In step 165, the software prompts the user to edit more questions. If the user elects to edit another question from the selected questionnaire, then the software returns to step 162 and repeats steps 163, 164, and 165. If the user is finished editing questions, then the software executes step 166 which saves or stores the modified questionnaire in memory 11. If the user desires to edit questions from a different questionnaire, the user may activate the “modify questionnaire” icon (not shown) and repeat the process depicted in FIG. 5.

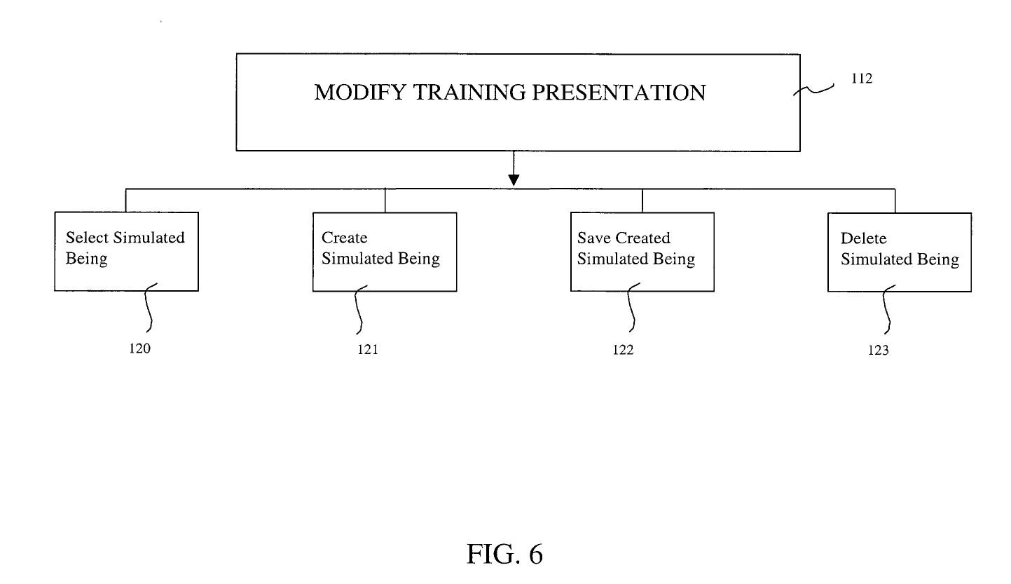

At step 103 of FIG. 2, the software presents the user with the option of modifying the simulated being that performs the training presentation. This procedure is depicted in FIG. 6. As indicated above, the presentation is performed or presented on display 15 by an animated character (or simulated being) or a person recorded in a video clip reciting or asking the user questions from the selected questionnaire. In step 120, the software provides the user a list of simulated beings and prompts the user to select a simulated being to ask the questions in the presentation. Alternatively, the software may allow the user to select a pre-recorded video that includes a human asking the questions in the presentation. In step 121, the software present the user with the option of creating a new simulated being for asking the questions during a presentation. A new simulated being may be created using conventional software such as the FACEWORKS software package from COMPAQ computer corporation. Such software is incorporated into the system of the present invention to enable the user to scan or import an image of, for example, a face, into the software. The software then maps the image and simulates facial movement of the image based upon the text to be spoken. For example, the user may scan in a photograph of a face and have the face ask the questions during the presentation. After the user creates a new simulated being, the simulated being is saved in memory 11 at step 122. Finally, at step 123, the software presents the user with option of deleting existing simulated beings or newly created simulated beings from memory 11.

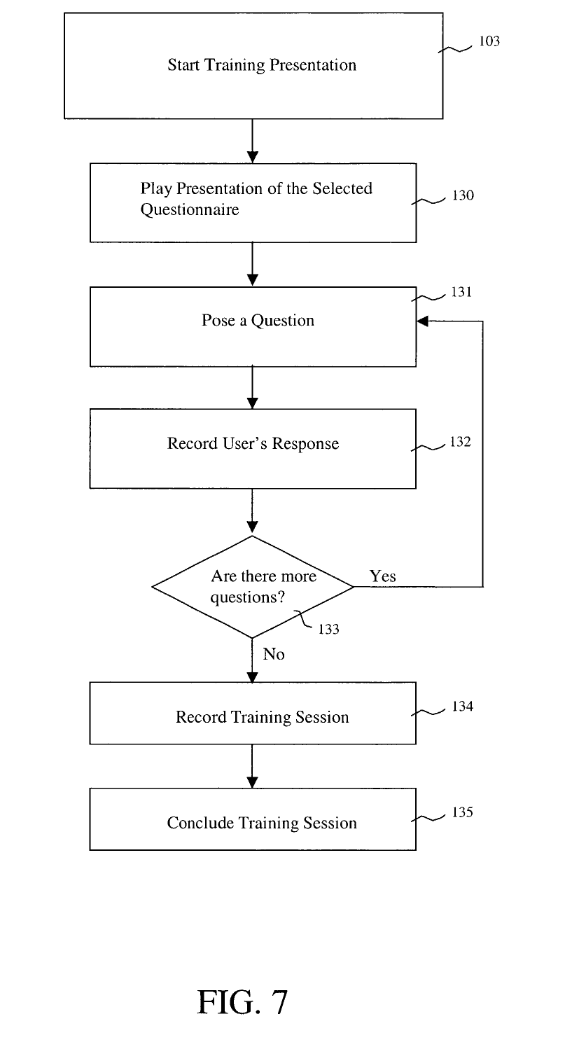

FIG. 7 depicts the sequence of events that occur when a user initiates a training presentation at step 103 of FIG. 2. In step 130, the user initiates a command to play the presentation of the selected questionnaire. In step 131, the software causes the simulated being to ask the first question from the selected questionnaire. The software may present the questions by generating a plurality of screens on display 15 depicting a simulated being presenting the question. Alternatively, the software may retrieve a video clip of a person asking the first question of the selected questionnaire and present it on display 15. In yet another embodiment, the user may select a random mode (as opposed to a sequential mode) for the training presentation wherein the questions are posed in a random order. In step 132, the user's response to the question is recorded in memory 11 when computer 10 receives response information from data input 20. The user indicates that a response is complete by activating input device 40 (e.g., depressing a keyboard key or mouse button), thereby prompting the software to save the response in memory 11. As should be apparent to one of ordinary skill in the art, a variety of methods exist for signaling that the response is complete such as depressing a spacebar or clicking on a “response complete” icon (not shown) shown on display 15. The interactive training software may also enable the user to set a time limit for responding to the questions. At the end of such a time limit, the software automatically advances to the next question.

After recording the most recent user response in memory 1, the software determines whether all of the questions of the questionnaire have been posed to the user. If there are more questions to be asked, then the software returns to step 131 and repeats steps 132 and 133. If there are no more questions to be asked, then the software advances to step 134 where a training session recording is generated. The training session recording includes all of the user's responses recorded during the training presentation. The training session is concluded at step 135.

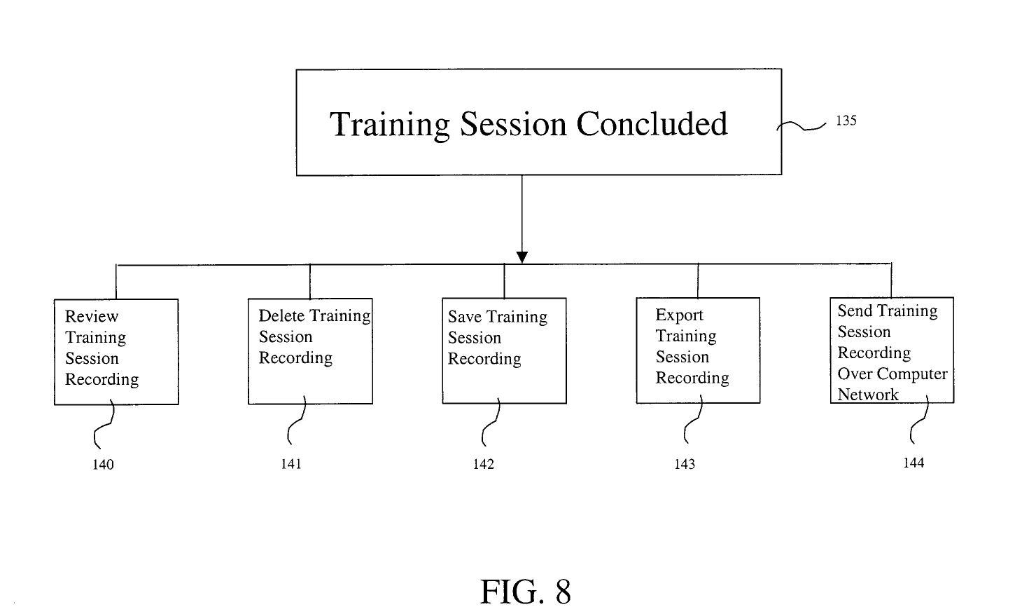

As shown in FIG. 8, after step 135 concludes the training session, the user is presented with several options. In step 140, the user can review or play back the training session recording. Using input device 40, the user may activate a “play recording” icon (not shown) presented on display 15 to initiate the playback of the recording. In step 141, the user can delete a training session recording from memory 11. The user may activate a “delete recording” icon (not shown) to delete the recording. It may be desirable to record another training session if the user was interrupted during the presentation or otherwise unsatisfied with the outcome of the training session. In step 142, the user can create a supplemental copy of the training session recording file by saving or storing the file to removable memory 13. The user may activate a “save recording” icon (not shown) to save the recording file to removable memory 13. In step 143 the user can export the training session recording to another computer application such as software enabling the user to convert the recording to textual form. The user may activate an “export recording” icon (not shown) to export the recording to another computer application. In step 144, the user can send the training session recording to another computer by activating output device 30. The user may activate a “send recording” icon (not shown) to send the recording file to another computer. In this manner, the training session recording may be reviewed and critiqued by others, for example, the user's employer. The training session recording can be formatted as a computer file or email attachment so that it is easily transferable. As should be apparent to one of ordinary skill in the art, there are a variety of file formats that could be used for the training session recording such as MPEG or MPEG-2. Moreover, the training session recording may be a video recording including both the audio and visual components of the presentation and responses, or an audio-only recording.

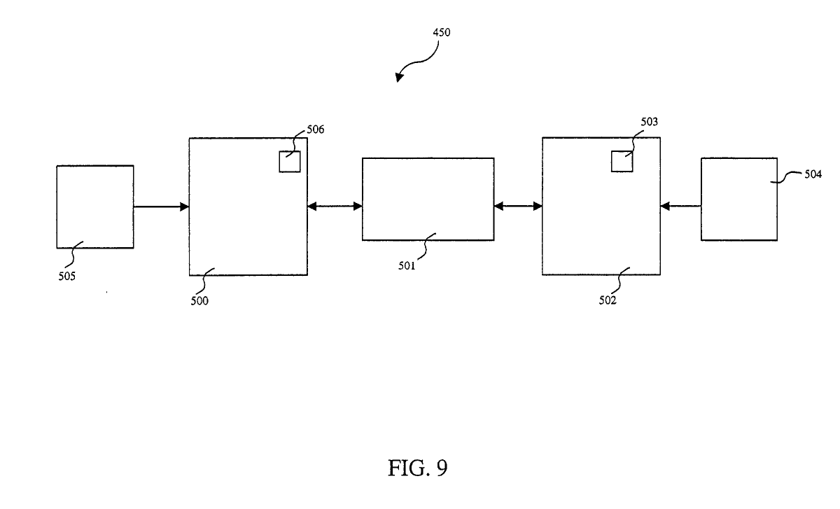

Referring now to FIG. 9, an alternate embodiment of a system for operating the software of the present invention is depicted as computer network 450. Computer network 450 generally includes central computer 502 and remote computer 500. Network 501 transfers data between central computer 502 and remote computer 500. Examples of network 501 include the internet, an intranet, an extranet, a local area network, or any other networking system. Input device 504 allows a user to input information and/or commands into central computer 502. Similarly, input device 505 allows a user to input information and/or commands into remote computer 500. Central computer 502 may include a portion 503 of interactive training software 100. Remote computer 500 may include another portion 506 of interactive training software 100. To run interactive training software 100 a user at remote computer 500 may access central computer 502 through network 501. Next, the remote user must access software portion 503. If the remote user gains access to software portion 503, software portions 503 and 506 cooperate to allow the user of remote computer 500 to run interactive training software 100 on remote computer 500. It should be understood that either or both of central computer 502 and remote computer 500 may include all of the components depicted in FIG. 1.

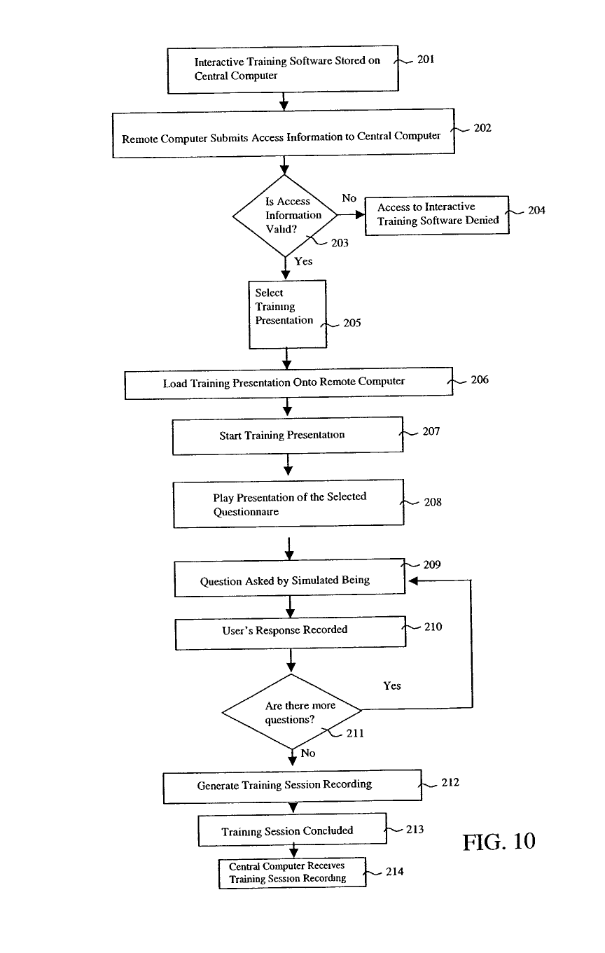

As shown in FIG. 10, in one embodiment of the invention, interactive training software 100 is stored on central computer 502 as shown in step 201. In step 202, users such as field agents can use remote computer 500 and software such as a web browser to gain access to interactive training software 100. Generally, as shown in step 202, the user may enter access information such as a password into remote computer 500 which then contacts central computer 502 through network 501. In step 203, the access information is verified by either remote computer 506 or central computer 502. In step 204, if the access information is not valid, for example the password is incorrect, access to interactive training software 100 is denied. If the correct access information is given, the user can activate interactive training software 100.

In step 205, the user begins by selecting a training questionnaire using input device 505. In step 206, the training presentation corresponding to the selected training questionnaire is loaded onto remote computer 500 via network 501 or is executed from central computer 502 and accessed through remote computer 506 via network 501. In step 207, the user starts the training presentation. In step 208, the presentation of the selected questionnaire is played on remote computer 500 in the manner described above. In step 209, the questions from the questionnaire are asked by the simulated being or animated character. In step 210, the user's responses to the questions asked are recorded. In step 211, interactive training software 100 determines if there are more questions to be asked. If there are more questions to be asked, the software then returns to step 209 and asks the next question in the questionnaire repeating steps 210 and 211. If there are no more questions to be asked, the software advances to step 212 and generates a training session recording. The training session recording is a file containing the recorded responses to all of the questions of the questionnaire.

In step 213, the user concludes the training session. In step 214, central computer 502 receives the training session recording either via network 501 or on a removable, computer readable media submitted by the user. The recording may then be reviewed by users with access to central computer 502. This embodiment of the invention may be patentably suitable for use by companies to train remotely located employees or independent contractors. For example, the training questionnaires could include questions a potential client might ask regarding a product or service or questions subordinate employees might ask a supervisor.

The foregoing description of the invention is illustrative only, and is not intended to limit the scope of the invention to the precise terms set forth. Although the invention has been described in detail with reference to certain illustrative embodiments, variations and modifications exist within the scope and spirit of the invention as described and defined in the following claims.

What is claimed is:

1. Software for simulating human interaction, including:
code for generating a questionnaire;
code for generating a computerized presentation;
code for presenting the questionnaire to a user;
code for generating a recording of input provided by the user during the presentation, the input including responses of the user to the questionnaire; and
code for enabling playback of the recording for review.

2. The software of claim 1, wherein the questionnaire includes a plurality of questions regarding one of a product and a service.

3. The software of claim 1, wherein the questionnaire includes a plurality of questions relating to a job interview.

4. The software of claim 1, further including code enabling a user to modify the questionnaire.

5. The software of claim 1, wherein the code for generating the questionnaire includes code for selecting a plurality of questions from a list of questions.

6. The software of claim 1, wherein the code for providing the questionnaire includes code for enabling user interaction to control the presentation.

7. The software of claim 6, wherein the user interaction includes actuating an input device of a computer.

8. The software of claim 6, wherein the user interaction includes actuating a graphical user interface of a computer.

9. The software of claim 1, wherein the code for generating a recording includes code for receiving input from a camera for recording the input provided by the user during the presentation.

10. The software of claim 1, wherein the code for enabling playback includes code for outputting the computerized presentation and the user input to a display.

11. The software of claim 1, wherein the recording includes an audio component.

12. The software of claim 1, further including code for transmitting the recording over a network.

13. The software of claim 1, wherein the computerized presentation includes a simulated being who presents the questionnaire.

14. The software of claim 13, further including code for enabling the user to select the simulated being from a plurality of simulated beings.

15. The software of claim 13, further including code for enabling the user to create the simulated being.

16. The software of claim 1, further including code for enabling the user to delete the recording.

17. The software of claim 1, further including code for enabling the user to export the recording.

18. The software of claim 1, wherein the code for presenting the questionnaire includes code for generating a plurality of screens depicting an animated figure presenting the questionnaire.

19. The software of claim 1, wherein the code for presenting the questionnaire includes code for generating a plurality of screens depicting a simulated being presenting the questionnaire.

20. The software of claim 1, wherein the code for presenting the questionnaire includes code for enabling a video recording to be played during the presentation, the video recording including a person presenting the questionnaire.

21. A method of simulating human interaction including the steps of:
preparing a computerized presentation including a plurality of questions;
enabling a user to receive the computerized presentation via a computer network; and
receiving responses of the user to the questions.

22. The method of claim 21, wherein the plurality of questions includes questions a potential client might ask the user.

23. The method of claim 21, further including the step of enabling the user to modify the questions.

24. The method of claim 21, further including the step of enabling the user to select the questions to be included in the presentation from a list of questions.

25. The method of claim 21, further including the step of enabling user interaction to control the presentation wherein a user interacts with the presentation by actuating an input device of a computer.

26. The method of claim 25, wherein the user interaction includes actuating a graphical user interface of a computer.

27. The method of claim 21, further comprising the step of enabling the user to record the user responses with a camera.

28. The method of claim 21, further comprising the step of viewing the responses on a display.

29. The method of claim 21, wherein the responses include an audio component.

30. The method of claim 21, wherein the receiving step includes the step of enabling transmission of the responses over a network.

31. The method of claim 21, wherein the computerized presentation includes a simulated being who presents the questions.

32. The method of claim 31, further including the step of enabling the user to select the simulated being from a plurality of simulated beings.

33. The method of claim 31, further including the step of enabling the user to create the simulated being.

34. The method of claim 21, further including the step of enabling the user to delete the responses.

35. The method of claim 21, further including the step of enabling a user to export the responses.

36. The method of claim 21, further including the step of enabling the user to transfer the responses to a computer readable storage media.

37. Software for simulating human interaction, including:
code for generating a questionnaire;
code for generating a display including a simulated being presenting the questionnaire; and
code for enabling a user to modify the questionnaire.

38. The software of claim 37, further including code for recording a response of the user to the questionnaire.

39. A method of simulating human interaction, including the steps of:
preparing a computerized presentation including a plurality of questions;
enabling a user to receive the computerized presentation; and
receiving responses of the user to the questions.

40. Software for simulating human interaction, including:
means for generating a questionnaire;
means for generating a computerized presentation;
means for presenting the presentation to a user;
means for generating a recording of input provided by the user during the presentation, the input including responses of the user to the questionnaire;
means for enabling playback of the recording for review;
means for modifying the questionnaire;
means for selecting questions to be included in the questionnaire;
means for enabling the user to control the presenting means; and
means for transmitting the recording over a network.
